(19) United States
(12) Patent Application Publication
(10) Pub. No.: US 2007/0268329 A1
(43) Pub. Date: Nov. 22, 2007

(54) METHOD FOR FREE SPRAYING OF THE NOZZLES OF AN INKJET PRINT HEAD

(76) Inventors: Olaf Turner, Berlin (DE); Uwe Hubler, Neuenhagen (DE); Axel Kieser, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/738,758

(22) Filed: Apr. 23, 2007

(30) Foreign Application Priority Data
May 19, 2006 (DE) 10 2006 023 542.8

(51) Int. Cl. B41J 2/165

(52) U.S. Cl. 347/22

(57) ABSTRACT

In a method for free spraying of the nozzles of an inkjet print head, in particular in a franking and/or addressing machine, in which the print media are directed past a stationary inkjet print head, in addition to printing an information-conveying print image, non-information-conveying a print image, serving exclusively for the free spraying, is applied on the print medium in a form that is for the print image evaluation, while retaining the same print position for the inkjet print head. Both print images are combined into a resulting print image. It is thus ensured that each nozzle is activated at least once during the print image generation. By the retention of the print position, time is saved and the letter travel is optimized.

### BACKGROUND OF THE INVENTION

1. Field of the Invention

The present invention concerns a method for free spraying of the nozzles of an inkjet print head (spraying the nozzles of an inkjet print head to clear those nozzles of clogging), in particular in a franking and/or addressing machine.

2. Description of the Prior Art

It is worthwhile to use the advantages of ink printing in the field of machine franking and/or addressing Printing in such devices ensues without contact by means of an inkjet print head (see, for example, DE 44 24 771C1 and EP 0 696 509 B1). Ink printing technology has the disadvantage, however, that often more ink is consumed for the cleaning of the inkjet print head than for the printing process. That is particularly serious in the case of individualized printing (as opposed to continuous printing.

A franking machine with an inkjet print head is known (see EP 0 696 509 B1 and U.S. Pat. No. 5,806,994) in which the letters are transported lying horizontally and the nozzle surface is arranged parallel to the moving letters. In this machine the nozzles that are used less frequently or not at all are freely sprayed upon printing, as long as no letter is present in front of the print head. For this purpose the letter transport device is provided with corresponding recesses, and a capture reservoir for the freely sprayed ink is arranged below these recesses. The ink consumption is reduced in this manner relative to the priming, but the horizontal letter transport and corresponding design measures are a requirement for achieving this result.

As used herein, “free spraying” means a one-time or repeated activation of one or more nozzles. In contrast to this, “priming” means a multiple, successive free spraying of all nozzles. Free spraying is consequently the ink-saving form of the cleaning of the nozzles of an inkjet print head.

An ink printer with a variable cleaning algorithm is known (see EP 0 934 828 A2) in which past franking imprints are recorded and evaluated (historical log) and from log this a cleaning regime (schedules) is derived. Information about maximum downtime, weekly letter arrival as well as number and type of the processing workflows per week are recorded in the historical log. The type of the imprints and thus the actual activation of the individual nozzles are not taken into account.

A device for cleaning an inkjet print head in a franking and/or addressing machine is known (see DE 10 2005 052 150.9-27) in which the inkjet print head is stationary, but can be pivoted behind a guide plate in a print window. During a cleaning procedure, the device seals the printhead orifices from the environment. By means of a transport device the print medium is caused to rest against the guide plate (tilted beyond the vertical) and is transported standing on an edge. Like the inkjet print head behind the guide plate, the cleaning and sealing device is arranged such that it can be displaced onto and away from the same guide plate. By means of associated displacement mechanism, the inkjet print head is alternatively pivotable into a printing position or into various cleaning regions as well as into a sealing position.

In the printing position the nozzle surface of the inkjet print head is arranged parallel to the guide plate and thus also parallel to the print medium.

In a first cleaning region, the inkjet print head is pivoted out from the printing position to an extent so that at a separation exists that is at least double the normal separation from the print medium, but all ink jets still reach the print medium. Use is made of the fact that, at the provided double separation, the inkjet printing drops disintegrate into smaller satellite drops, whose scatter region is so large that a recognizable print pattern is no longer present.

Given higher transport speeds for the print medium, this method can be applied only in a limited manner due to the mass inertia of the inkjet print head that must be pivoted. The speed of the rotation movement is also limited in order to avoid an unwanted flinging of ink due to the pivoting.

### SUMMARY OF THE INVENTION

An object of the invention is to improve the print quality and extend the lifespan of an inkjet print device as well as to provide an optimally high letter throughput in a franking or addressing device that uses an inkjet printhead.

More specifically, an object of the invention is to provide a method for free spraying of the nozzles of an inkjet print head in a franking and/or addressing machine in which the transport speed of the print medium is not limited, and which is suitable both for horizontally-situated print medium transport and transport of print media standing on an edge.

The invention is based on the observation that, in countries with large amounts of incoming mail, it has now become typical to provide postal shipments (in particular letters) with machine-readable, coded, specialized print images (indicia imprint including cliché) to avoid postage losses as well as for security reasons.

This occurs in the form of one-dimensional barcodes or, more recently in the form of two-dimensional barcodes (see, for example, DE 20 2005 000 255 U1).

The individual image points (pixels) of a print image that are evaluated are represented by a number of print points (dots).

A print point arises by a one-time activation of a nozzle. Given a pixel size with 0.5 mm edge length, around 600 dots would represent at one pixel, given a printing density of 200 dpi (dots per inch).

According to the invention, a non-information-conveying print image as applied onto the print medium in a mode that is irrelevant for the print image evaluation, this non-information-conveying print image serving exclusively for the free spraying, in addition to applying an information-conveying image, while retaining the same print position of the inkjet print head. This means that for the free spraying, a significantly fewer number of dots than are required for an information-conveying image point or pixel are to be applied onto the print medium with the appertaining nozzle. The dots can be inserted into what are known as the white pixels and superimposed on the dark pixels, or can be arranged otherwise without adulterating the information content.

At least the less-used or barely-used nozzles are activated once for the generation of the additional print image. The print image can thereby extend over one or more print media.

For information-conveying print images in which the nozzles in the upper and lower margins (boundary regions) are activated less or not at all, the free spraying pattern is correspondingly adapted. Consistent therewith, the print density within the additional print image is established differently such that this print density is greater with regard to the upper and lower edges and in the overlap region than in the remaining region. This also achieves ink savings and is the preferred free spraying embodiment. In order to be able to make an appropriate selection, a specific number of additional print patterns are generated and stored. Time is saved and the letter travel is optimized by the retention of the print position.

### DESCRIPTION OF THE DRAWINGS

FIG. 1 shows an exemplary indicia imprint with enlarged details for explaining the invention wherein,
imprint (a) is a complete indicia imprint with two-dimensional barcode, advertising cliche and other supplementary services such as one-dimensional address barcode,
enlargement (b) is a detail from the two-dimensional barcode from imprint (a), and
enlargement (c) is a detail from enlargement (b).

FIG. 2 provides an overview of possible non-information-conveying free spray print images, wherein
imprint (a) distribution of the dots over of the print medium given participation of all nozzles,
imprint (b) distribution of the dots over the print medium given advantageous participation of the nozzles in the upper and lower margins,
imprint (c) distribution of the dots on a chronologically subsequent vertical line given participation of all nozzles,
imprint (d) distribution of the dots on two chronologically subsequent vertical lines aligned with one another given participation of the nozzles in the upper and lower margins,
imprint (e) distribution of the dots on a chronologically preceding vertical line given participation of all nozzles,
imprint (f) distribution of the dots on two chronologically preceding vertical lines aligned with one another given participation of the nozzles in the upper and lower margins,

FIG. 3 is a block diagram for the printer control in accordance with the invention.

FIG. 4 is a flowchart for the block diagram according to FIG. 3.

### DESCRIPTION OF THE PREFERRED EMBODIMENTS

For simplification and for an easier understanding, the representations below are in somewhat schematic form.

A complete indicia imprint for test purposes according to imprint (a) in FIG. 1 includes FIG. 1, in chronological order beginning at the right, the conventional franking imprint, the franking imprint in the two-dimensional barcode, an advertising cliche and other supplementary services such as a one-dimensional address barcode arranged below said advertising cliché.

A sub-region of the franking imprint in the two-dimensional barcode is shown enlargement (b) of FIG. 1. Here it can already be easily seen how the pixels p are composed of multiple dots d.

The region according to enlargement (b) FIG. 1b is shown so enlarged in enlargement (c) that the dimensions of one pixel can be easily seen in x- and y-coordinates, and it can also be seen that individual dots d of the free spray image that lie within the white pixels of the relevant print image Dr. It is clear that these dots inevitably are not considered by an evaluation system that makes the evaluation at a level comparable to the pixel size.

Imprint (a) in FIG. 2 illustrates the case of the free spray image Db (dots enlarged in deviation from reality) being distributed over the information-conveying print image Dr and the remaining print medium B.

Imprint (b) in FIG. 2 illustrates a free spray image Db that particularly takes into account the upper and lower margins of the maximum print region. These margins are the regions in which the nozzles are otherwise seldom activated or are not activated at all. This variant is particularly ink-saving and therefore preferred.

Imprint (c) in FIG. 2 illustrates a free spray image Db in which all nozzles are activated simultaneously after the two-dimensional barcode such that a vertical line exists. In this variant the actual intensity of the activation of the individual nozzles for the generation of the information-conveying print image Dr is not considered (taken into account). However, it is still ensured that each nozzle is activated at least one time per print medium B.

Imprint (d) in FIG. 2 illustrates a free spray image Db is shown in which all nozzles in the upper and lower margins are activated simultaneously after the two-dimensional barcode such that two vertical print lines parallel to one another exist. It is hereby required that all nozzles are activated for the barcode region. This variant has the same effect as the variant according to imprint (b) FIG. 2 and is consequently equally advantageous.

Imprint (e) in FIG. 2 illustrates a free spray image Db in which all nozzles are activated simultaneously before the two-dimensional barcode. This pattern is the counterpart to the pattern according to imprint (e) of FIG. 2.

Imprint (f) in FIG. 2 illustrates a free spray image Db in which all nozzles in the upper and lower margins are activated simultaneously before the two-dimensional barcode. This pattern is the counterpart to the pattern according to imprint (d) in FIG. 2.

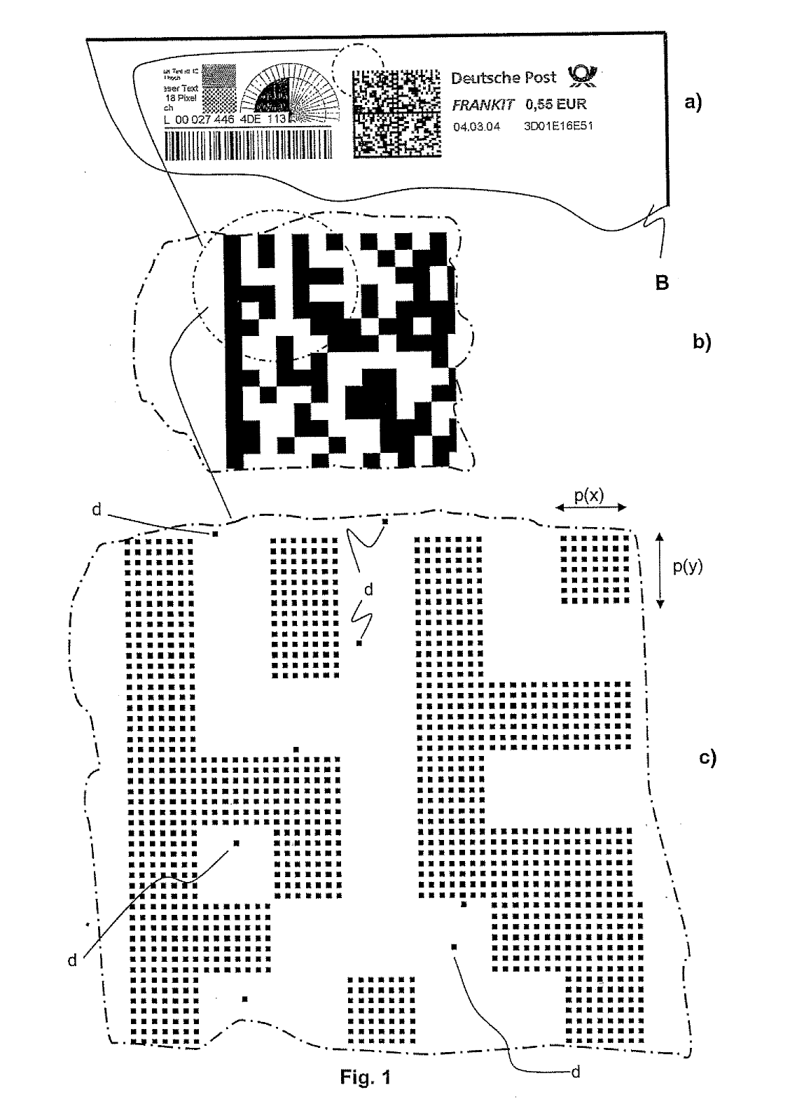

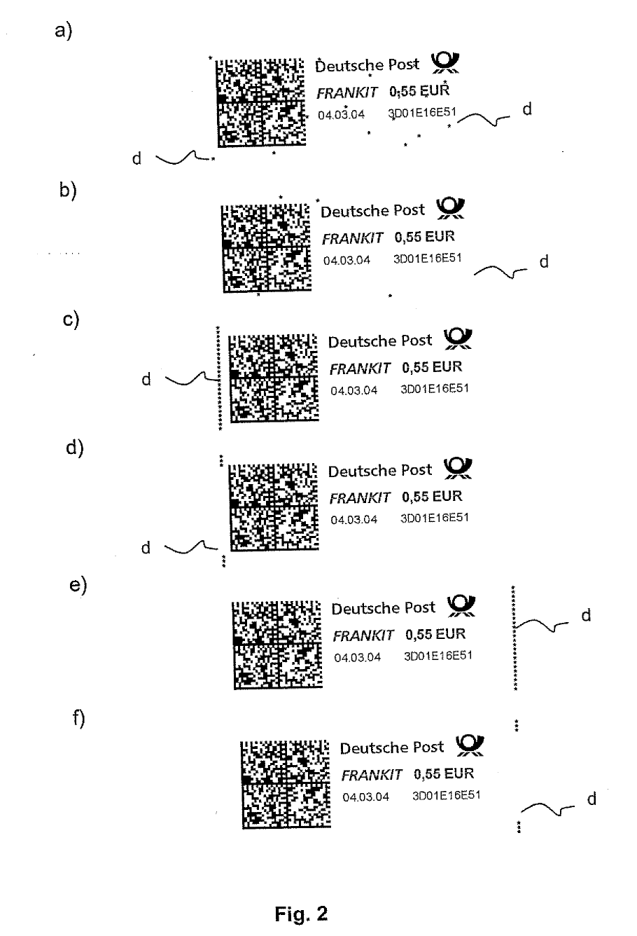

A block diagram of the printer control is shown in FIG. 3. The printer control has a memory 1 for the information-conveying print image Dr. The information-conveying print image Dr contains information concerning postage, mailing date, franking machine, advertising cliche as well as supplementary letter services such as express mail or bulk mail. The information for these items is determined by upstream devices such as letter scales and dimension scanning components as well as operator requests. In addition to the memory 1, a memory 2 is provided into which is input an empirically-determined number of non-information-conveying print patterns or free spray patterns Di1 through Din. Depending on the current and expected relevant print images Dr, the suitably expanded free spray pattern Di is selected manually or automatically. Both memories 1 and 2 are connected in a bi-directional manner with a microprocessor 5. Moreover, the franking data input 3 is connected to the microprocessor 5 such that it arrives in a unidirectional manner at said microprocessor 5. The data supplied by the franking data input 3 are further processed in the microprocessor 5 into the current print image Dr and are buffered in the memory 1. Furthermore, a memory 4 in which the resulting print image D (composed of information-conveying and non-information-conveying print images Dr, Db) is buffered is connected in a bi-directional manner with the microprocessor 5. The microprocessor 5 is connected in a unidirectional manner with a printing device 6 that receives the current resulting print image D from the microprocessor 5.

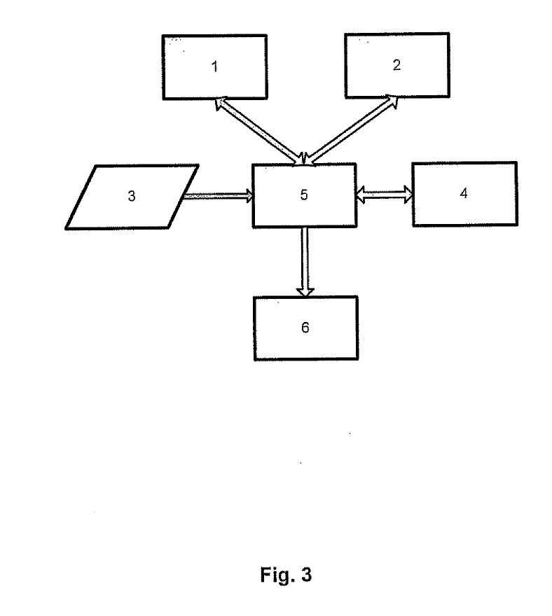

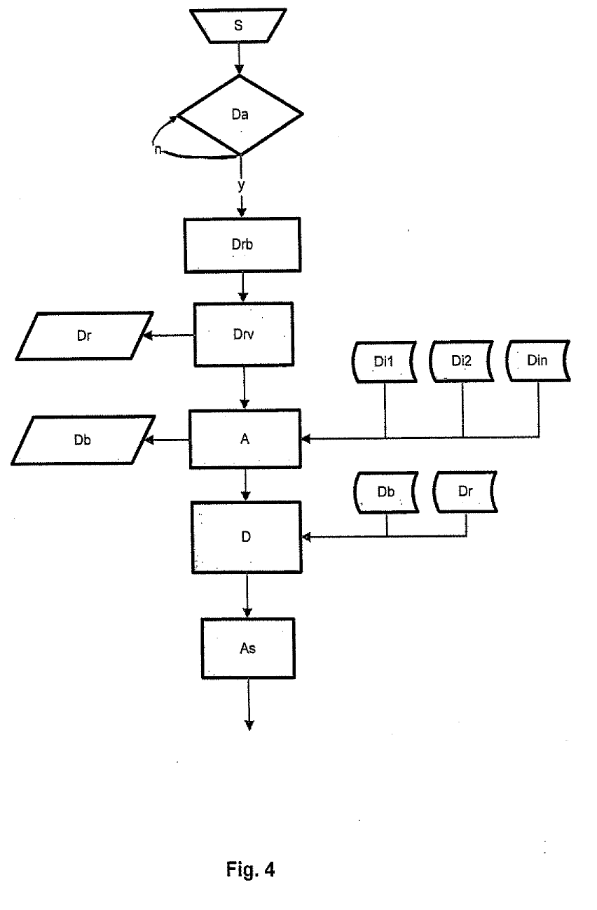

The associated flowchart for diagram regarding the block diagram according to FIG. 3 is shown in FIG. 4. With the intake of a print medium B into the franking machine, the leading edge of the print medium B passes a sensor and therewith initiates the start S for the print job Da. The franking print calculation Drb and subsequently the franking print preparation Drv ensue based on the postage-relevant information from the franking data input 3. The information-conveying print image Dr compiled and is buffered. The information as to which nozzles are activated to which extent simultaneously accumulates in the franking print preparation Drv. This information serves for selection A of a suitable non-information-conveying print pattern Di composed of a number n of permanently-stored print patterns Di1 through Din. This print pattern Di is processed to compile a non-information-conveying print image Db that is buffered. The information-conveying print image Dr and the supplementary non-information conveying print image Db are combined into a resulting print image D, and this is forwarded to the print control. The printing process is ended with the execution of all print commands per print medium B.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for free spraying of nozzles of a stationary inkjet printhead onto print media directed past said stationary inkjet printhead, said method comprising the steps of:
compiling an information-conveying print image to be printed on at least one of said media;
compiling a non-information conveying print image exclusively for free spraying onto said at least one of said media in a mode that is irrelevant for evaluation of said information-conveying print image; and
simultaneously printing said information-conveying print image and free spraying nozzles of said printhead onto said at least one of said media according to said non-information conveying image, while maintaining said at least one of said media in a same print position relative to said inkjet printhead.

2. A method as claimed in claim 1 wherein said information-conveying print image is comprised of a plurality of pixels that are individually evaluatable for evaluating said information-conveying print image, and wherein the step of compiling said non-information-conveying print image comprises compiling said non-information-conveying print image to consist of a plurality of print dots per pixel of said non-information conveying print image that have a characteristic selected from the group consisting of print dot size and number of print dots per pixel, that is substantially smaller than a corresponding characteristic of each pixel of said information-conveying print image.

3. A method as claimed in claim 1 comprising compiling said non-information-conveying print image to cause every nozzle of said inkjet printhead to be activated at least once in order to generate said non-conveying print image.

4. A method as claimed in claim 3 comprising generating only respective portions of said non-information-conveying image on respective media directed past said inkjet printhead, so that the complete non-information conveying print image is collectively printed on said respective print media.

5. A method as claimed in claim 1 wherein the step of compiling said non-information-conveying print image comprises compiling said non-information-conveying print image with a density of printed dots that is non-uniform over an area encompassed by said non-information-conveying print image.

6. A method as claimed in claim 4 wherein said area encompassed by said non-information-conveying print image comprises an upper edge and a lower edge and a remaining region between said upper edge and said lower edge, and comprising compiling said non-information-conveying print image with a density of said printed dots that is larger toward each of said upper edge and said lower edge than in said remaining region.

7. A method as claimed in claim 1 wherein the step of compiling said non-information-conveying image comprises generating and storing a plurality of different non-information-conveying print patterns, as stored patterns, and selecting one of said stored patterns and compiling a non-information-conveying print image to be printed from said stored pattern, and combining said non-information-conveying print image compiled from said stored pattern with said information-conveying print image, to form a resulting print image, and printing said resulting print image on at least one of said print media.
